(19) United States
(12) Patent Application Publication
(10) Pub. No.: US 2016/0114246 A1
(43) Pub. Date: Apr. 28, 2016

(54) GAME PROGRAM AND INFORMATION PROCESSING DEVICE

(71) Applicant: DeNA Co., Ltd., Tokyo (JP)

(72) Inventors: Ryosuke MASHIKO, Tokyo (JP); Yohei MURAI, Tokyo (JP)

(21) Appl. No.: 14/863,222

(22) Filed: Sep. 23, 2015

(30) Foreign Application Priority Data
Oct. 27, 2014 (JP) 2014-218282

(51) Int. Cl. A63F 13/497; A63F 13/44; A63F 13/822

(52) U.S. Cl. CPC A63F 13/497; A63F 13/822; A63F 13/44

(57) ABSTRACT

The inventive game program, as a result of a player performing a batch operation, directs a computer to successively execute a process in which an attack-induced battle parameter consumption value and a current value of a battle parameter are compared to determine whether or not the player's battle parameter is insufficient, and, if it is determined that the player's battle parameter is insufficient, a process in which the battle parameter is recovered with the help of the player's recovery item by adding the value of battle parameter recovery due to said recovery item to the current value of the battle parameter and a process in which an attack on the opponent is carried out by subtracting the value of attack-induced battle parameter consumption from the current value of the recovered battle parameter.

The present application claims the benefit of Japanese Patent Application No. JP2014-218282, filed on Oct. 27, 2014, the content of which is incorporated herein in its entirety by reference.

### STATEMENT REGARDING PRIOR DISCLOSURES BY THE INVENTORS

The inventors of the present application authored and disclosed the subject matter of the present application on May 24, 2014. These prior disclosures have been submitted in an Information Disclosure Statement in the present application, including the URLs, a print-out of the web site providing the game service (e.g., homepage), print-out of the web site providing the game service (e.g., the homepage of an event), print-out of the web site providing the game service (e.g., an announcement page of an event), and print-out of the game screen of the game application (e.g., the screen shot describing the game)

### BACKGROUND

1. Technical Field

The present invention relates to a game program (e.g., non-transitory computer readable medium having machine-executable instructions with which a computer having a storage and a hardware processor, for providing a service) and an information processing device.

2. Related Art

Game programs are known where, as a result of a player performing a batch operation for using a recovery item and carrying out an attack on an opponent in a single operation, a computer is directed to successively execute a recovery process that recovers a battle parameter and an attack process that consumes the recovered battle parameter and carries out an attack on the opponent (e.g., Patent Document 1).

### PRIOR ART DOCUMENTS

### Patent Documents

[Patent Document 1] Japanese Patent Publication No. 5216152

### SUMMARY OF THE INVENTION

### Problems to be Solved by the Invention

In such a game program, battle parameters can be recovered with the help of recovery items that recover battle parameters in accordance with the recovery values of the recovery items. However, some of the recovery value that the recovery items provide may end up being wasted because the battle parameters have maximum values configured therein.

The present invention has been devised with these circumstances in mind and it is an object of the invention to recover battle parameters without waste.

### SUMMARY

The main aspect of the present invention intended to eliminate the above-mentioned problems is a game program (e.g., non-transitory computer readable medium having machine-executable instructions with which a computer having a storage and a hardware processor, for providing a service) wherein, a computer is directed to execute:

a recording process which records a battle parameter consumed during a battle with an opponent and a recovery item for recovering the battle parameter in a storage module in association with a player, and

as a result of the player performing a batch operation for recovering the battle parameter and carrying out an attack on the opponent in a single operation,

a determination process which determines whether or not the player's battle parameter is insufficient based on the result of comparing the value of attack-induced consumption of the battle parameter and the current value of the battle parameter; and

if it is determined that the player's battle parameter is insufficient,

a recovery process which recovers the player's battle parameter with the help of the player's recovery item by adding the value of battle parameter recovery due to said recovery item to the current value of the battle parameter; and

a battle process which successively carries out an attack process in which an attack is carried out on the opponent by subtracting the value of attack-induced consumption of the battle parameter from the current value of the recovered battle parameter.

Other features of the present invention will become apparent from this Description and the accompanying Drawings.

### BRIEF DESCRIPTION OF THE DRAWINGS

FIG. 1 A diagram illustrating an example configuration of the entire game system 1.

FIG. 2 A block diagram illustrating the functional configuration of the server device 10.

FIG. 3 A diagram illustrating an example data structure of character information.

FIG. 4 A diagram illustrating an example data structure of item information.

FIG. 5 A diagram illustrating an example data structure of skill information.

FIG. 6 A diagram illustrating an example data structure of player information.

FIG. 7 A diagram illustrating an example data structure of proprietary character information.

FIG. 8 A diagram illustrating an example data structure of proprietary item information.

FIG. 9 A diagram illustrating an example data structure of proprietary skill information.

FIG. 10 A diagram illustrating an example data structure of skill configuration information.

FIG. 11 A block diagram illustrating the functional configuration of the player terminal 20.

FIG. 12 A flow chart used to illustrate an example of operation of the game system 1.

FIG. 13 A diagram illustrating an example game screen 50.

### DETAILED DESCRIPTION

At least the following will be apparent from this Description and the accompanying Drawings.

Namely, this is a game program (e.g., non-transitory computer readable medium having machine-executable instructions with which a computer having a storage and a hardware processor, for providing a service) wherein, a computer is directed to execute:

a recording process which records a battle parameter consumed during a battle with an opponent and a recovery item for recovering the battle parameter in a storage module in association with a player, and

as a result of the player performing a batch operation for recovering the battle parameter and carrying out an attack on the opponent in a single operation,

a determination process which determines whether or not the player's battle parameter is insufficient based on the result of comparing the value of attack-induced consumption of the battle parameter and the current value of the battle parameter; and

if it is determined that the player's battle parameter is insufficient,

a recovery process which recovers the player's battle parameter with the help of the player's recovery item by adding the value of battle parameter recovery due to said recovery item to the current value of the battle parameter; and

a battle process which successively carries out an attack process in which an attack is carried out on the opponent by subtracting the value of attack-induced consumption of the battle parameter from the current value of the recovered battle parameter.

In accordance with such a game program, if the battle parameter is insufficient, the value of battle parameter recovery due to the recovery item is added even before the current value of the battle parameter is reduced to zero, and the value of attack-induced consumption of the battle parameter is subtracted thereafter. For this reason, it becomes possible for the battle parameter to be recovered without waste.

In addition, this game program may be adapted such that the battle process successively carries out the determination process, the recovery process, and the attack process only if the batch operation has been performed by the player within a preset time limit.

In accordance with such a game program, the player can conduct the game to his or her advantage even within a limited time period because the use of the recovery item and the attack on the opponent are carried out promptly.

In addition, this game program may be adapted such that the battle process authorizes the player's batch operation to be repeatedly performed within the above-mentioned time limit, and

the attack process maintains the value of attack-induced consumption of the battle parameter at a fixed level for a predetermined period within the above-mentioned time limit whenever the batch operation is performed by the player.

In accordance with such a game program, the battle parameter can be recovered without waste even if the current value of the battle parameter cannot be reduced to zero when the battle parameter is incrementally consumed by attacks each time the batch operation is performed by the player.

In addition, this game program may be adapted such that the recording process records, in the storage module in association with players, multiple types of the recovery items with respectively different maximum values up to which the battle parameter can be recovered when the current value of the battle parameter is zero, and

when the player's battle parameter is recovered, the recovery process selects a recovery item capable of making the current value of the recovered battle parameter greater than the value of attack-induced consumption of the battle parameter from among the multiple types of recovery items.

In accordance with such a game program, the battle parameter can be recovered in an efficient manner because the selected recovery item is appropriate to the game situation.

In addition, this game program may be adapted such that

the recording process records, in the storage module in association with players, multiple types of the recovery items with respectively different maximum values up to which the battle parameter can be recovered when the current value of the battle parameter is zero, and

when the player's battle parameter is recovered, the recovery process selects a recovery item with the lowest maximum value up to which the battle parameter can be recovered when the current value of the battle parameter is zero, from among the multiple types of recovery items capable of making the current value of the recovered battle parameter greater than the value of attack-induced consumption of the battle parameter.

In accordance with such a game program, the battle parameter can be recovered in an efficient manner because the selected recovery item is appropriate to the game situation.

Next, this is an information processing device provided with:

a storage module which stores a battle parameter consumed during a battle with an opponent and a recovery item for recovering the battle parameter in association with a player, and

as a result of the player performing a batch operation for recovering the battle parameter and carrying out an attack on the opponent in a single operation,

a determination processing module which determines whether or not the player's battle parameter is insufficient based on the result of comparing the value of attack-induced consumption of the battle parameter and the current value of the battle parameter, and

if it is determined that the player's battle parameter is insufficient,

a recovery processing module which recovers the player's battle parameter with the help of the player's recovery item by adding the value of battle parameter recovery due to said recovery item to the current value of the battle parameter, and

an battle processing module which possesses functionality to successively carry out an attack process in which an attack is carried out on the opponent by subtracting the value of attack-induced consumption of the battle parameter from the current value of the recovered battle parameter.

Such an information processing device allows for battle parameters to be recovered without waste.

### Embodiments

### <<Configuration of Game System 1>>

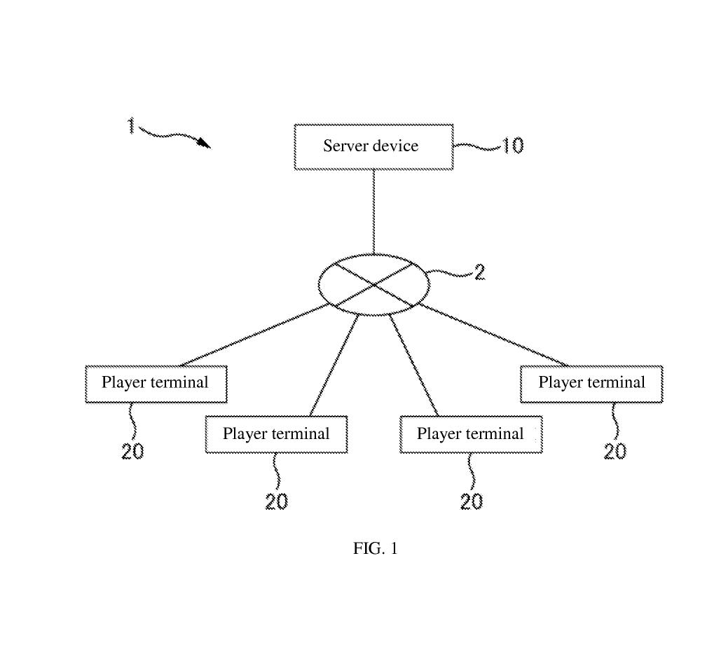

FIG. 1 is a diagram showing an example configuration of the entire game system 1. The game system 1 provides various game-related services to the player over a network 2 (for example, the Internet) and includes a server device 10 and multiple player terminals 20.

The game system 1 according to the present embodiment can provide a battle game conducted by players using game content objects. The description below will address a battle-type card game conducted using character cards (hereinafter referred to simply as “characters”), which are an example of game content objects.

The battle-type card game of the present embodiment is a battle game in which characters battle each other to determine a winner within a time limit. A player carries out an attack on an opponent's character by directing a player character to actuate its skills using battle points. If the battle points are insufficient at such time, the player character cannot carry out an attack. For this reason, the player needs to recover the battle points using a recovery item. The recovery of the battle points can be performed automatically over time, without using recovery items. However, recovering the battle points promptly using a recovery item in order to repeat the attack within a limited battle time makes it possible for the player to conduct the game to his or her advantage. In addition, in the present embodiment, the player only has to perform a single batch operation in order to use a recovery item and successively carry out an attack on an opponent. As a result, the interval between recovery and attack during the limited battle time can be shortened, which makes it possible for the player to conduct the battle game to even greater advantage.

### <Configuration of Server Device 10>

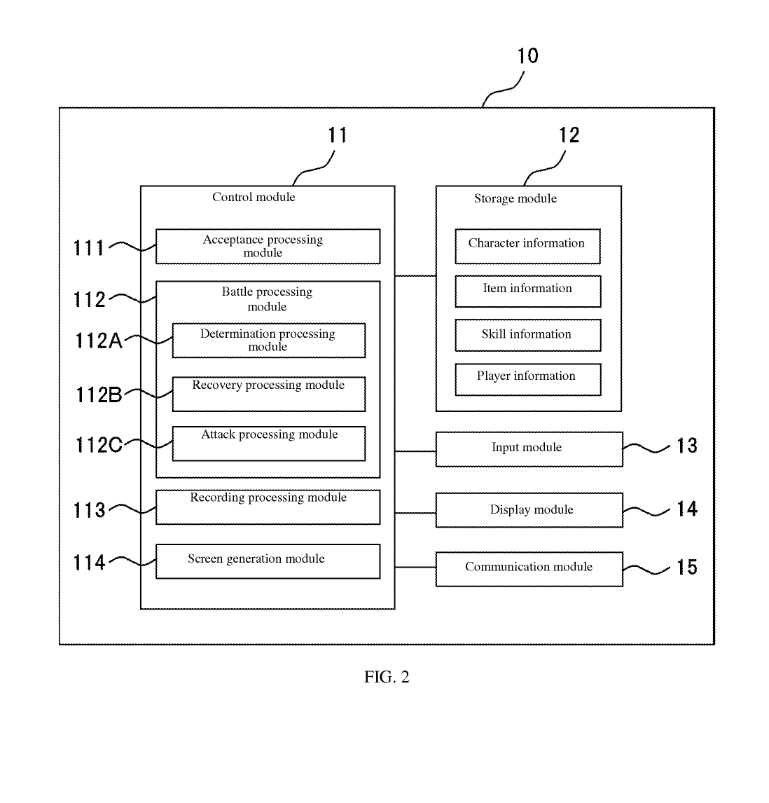

FIG. 2 is a block diagram illustrating the functional configuration of the server device 10. The server device 10 is an information processing device (for example, a workstation, a personal computer, etc.) used by a system administrator to operate and manage a variety of services. Upon receiving various commands (requests) from player terminals 20, the server device 10 transmits (responds by sending) game programs operational on the player terminals 20 and various types of data and web pages (game screens, etc.) created using a markup language (HTML, etc.) compliant with the specifications of the player terminals 20. This server device 10 has a control module 11, a storage module 12, an input module13, a display module 14, and a communication module 15.

The control module 11, along with transferring data between the components, exercises overall control over the server device 10, and is implemented using a CPU (Central Processing Unit) that runs a predetermined program stored in memory. The control module 11 of the present embodiment is provided with at least an acceptance processing module 111, a battle processing module 112, a recording processing module 113, and a screen generation module 114.

The acceptance processing module 111 possesses functionality to carry out processing to receive operational input from the player. When the player performs gaming operations on the player terminal 20, the acceptance processing module 111 of the present embodiment receives operational information (operational commands, etc.) over a network, thereby accepting operational input from the player.

The battle processing module 112 possesses functionality to carry out processing to decide a winner in the battle waged by the characters. The battle processing module 112 of the present embodiment is provided with a determination processing module 112A, a recovery processing module 112B, and an attack processing module 112C. The determination processing module 112 possesses functionality to carry out various types of determination-related processing. The recovery processing module 112B possesses functionality to carry out processing to recover battle parameters used during a battle. The attack processing module 112C possesses functionality to carry out processing that initiates an attack on an opponent character by consuming a battle parameter in order to reduce the opponent character's hit point parameter.

The recording processing module 113 possesses functionality to carry out processing to write various types of data to the storage area in the storage module 12. For example, the recording processing module 113 of the present embodiment records battle parameters consumed during battles and recovery items for recovering the battle parameters in the storage module 12 in association with each player.

The screen generation module 114 possesses functionality to carry out processing used to generate screen data for displaying a game screen on a player terminal 20. The screen generation module 114 of the present embodiment generates HTML data as screen data corresponding to a game screen.

The storage module 12 has a ROM (Read Only Memory), which is a read-only storage area where operating system software is stored, and a RAM (Random Access Memory), which is a rewritable storage area used as a work area for arithmetic processing by the control module 11, and is implemented as a non-volatile storage device, such as a flash memory, a hard disk, and the like. The storage module 12 of the present embodiment records at least character information, item information, skill information, and player information. It should be noted that each of these information elements will be described in more detail below.

The input module 13 is used by a system administrator for the entry of various types of game service-related data (e.g., character information, item information, etc.), and is implemented, for example, using a keyboard, a mouse, and the like.

The display module 14, which is used to display an operation screen for use by a system administrator in response to a command from the control module 11, is implemented, for example, as a liquid crystal display (LCD: Liquid Crystal Display), or the like.

The communication module 15, which is used for communication with the player terminals 20, has receiver functionality for receiving various types of data and signals transmitted from the player terminals 20 and transmitter functionality for transmitting various types of data and signals to the player terminals 20 in response to commands from the control module 11. The communication module 15 is implemented, for example, as an NIC (Network Interface Card), or the like.

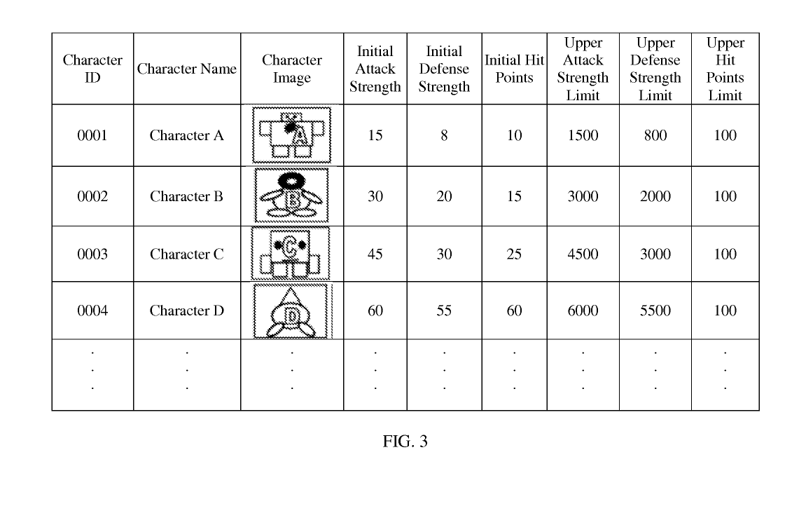

FIG. 3 is a diagram illustrating an example data structure of character information. This character information has configured therein, in association with a character ID, at least a character name and a character image, as well as the initial and maximum values of initial attack strength, initial defense strength, initial hit points, maximum attack strength, maximum defense strength, maximum hit points and various other capability parameters.

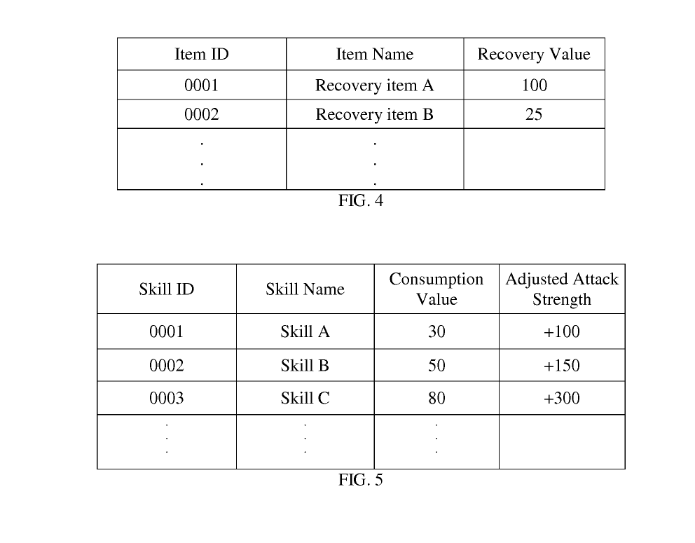

FIG. 4 is a diagram illustrating an example data structure of item information. This item information has configured therein, in association with an item ID, at least an item name and a recovery value. In the present embodiment, a battle parameter recovery value is configured respectively for each type of recovery item.

FIG. 5 is a diagram illustrating an example data structure of skill information. This skill information has configured therein, in association with a skill ID, at least a skill name, a consumption value, and an attack strength adjustment. In the present embodiment, a battle parameter consumption value is configured respectively for each type of skill In addition, the adjustment is performed such that a character's attack strength increases as a result of skill actuation.

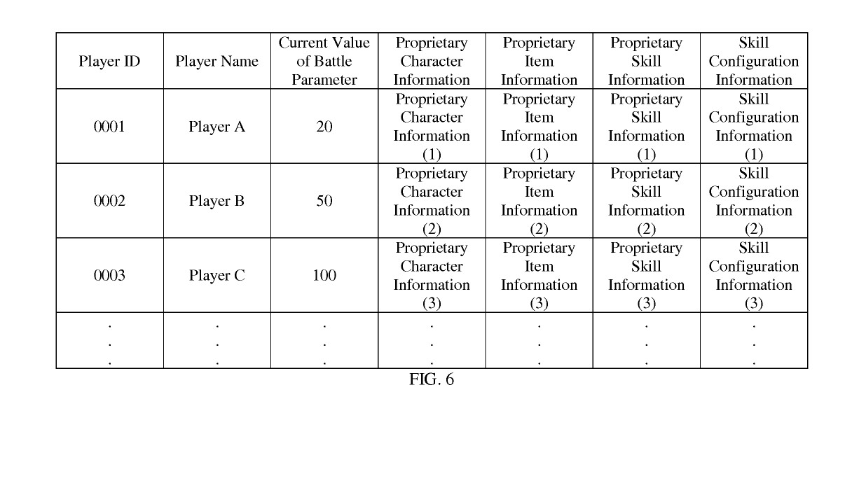

FIG. 6 is a diagram illustrating an example data structure of player information. This player information has configured therein, in association with a player ID, at least a player name, the current value (current battle points) of the battle parameter, proprietary character information, proprietary item information, proprietary skill information, and skill configuration information.

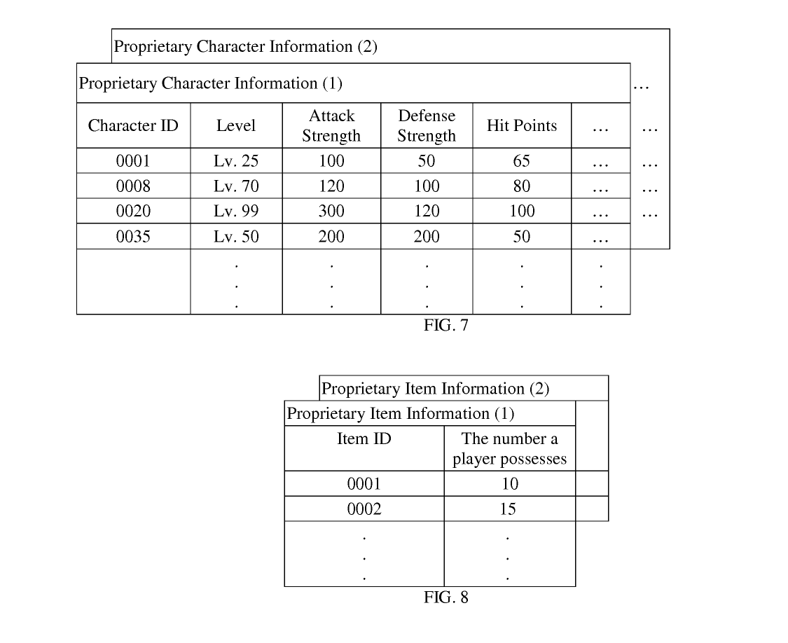

FIG. 7 is a diagram illustrating an example data structure of proprietary character information. The proprietary character information represents information relating to the characters belonging to the players (hereinafter referred to as “proprietary characters”). This proprietary character information has configured therein, in association with the character IDs of the proprietary characters, at least the level, attack strength, defense strength, and hit points of the characters. The level, attack strength, defense strength, and hit points are parameters indicating the current capability values configured for the characters belonging to the players. These various parameters are updated as the game progresses.

FIG. 8 is a diagram illustrating an example data structure of proprietary item information. Proprietary item information represents information relating to the items the players possess (hereinafter referred to as “proprietary items”). This proprietary item information has configured therein, in association with item IDs, at least the number of the items owned.

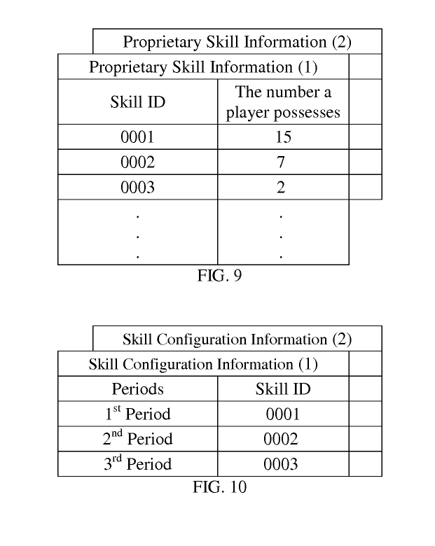

FIG. 9 is a diagram illustrating an example data structure of proprietary skill information. The proprietary skill information represents information relating to the skills the players possess (hereinafter referred to as “proprietary skills”) This proprietary skill information has configured therein, in association with skill IDs, at least the number of the proprietary skills

FIG. 10 is a diagram illustrating an example data structure of skill configuration information. The skill configuration information represents information used to pre-configure skills actuated during an attack in the course of a battle. This skill configuration information has configured therein, for each predetermined period, the skill IDs of the skills actuated during an attack. In other words, the skills generated during each period are respectively configured to be kept constant. In the present embodiment, the battle time is set to 60 seconds. The battle time is composed of a first period, a second period, and a third period produced by division into 20-second intervals. Namely, the first period is a period from the start of the battle until the elapse of the initial 20 seconds. The second period is a period from the end of the first period until the elapse of the next 20 seconds. The third period is a period from the end of the second period until the elapse of the last 20 seconds. In the present embodiment, the player can perform configuration before the start of the battle by allocating skills selected from the player's own proprietary skills respectively to each period in advance.

### <<Configuration of Player Terminal 20>>

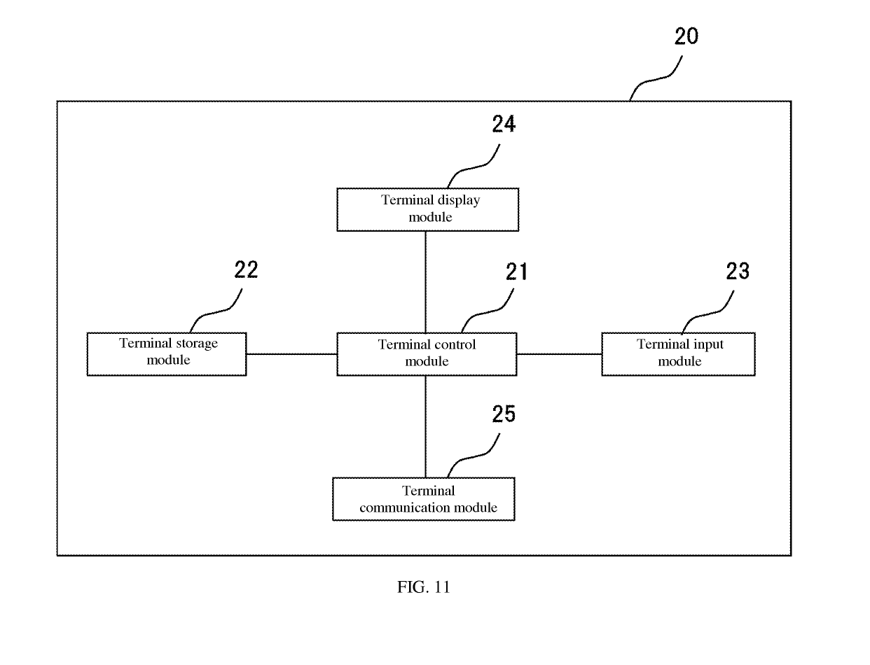

FIG. 11 is a block diagram illustrating the functional configuration of a player terminal 20. The player terminals 20 are information processing devices owned and used by the players (e.g., tablet terminals, mobile phone terminals, smartphones, and the like). Due to the web browser functionality they possess, the player terminals 20 are capable of on-screen display of web pages (game screens, and the like) transmitted from the server device 10. A player terminal 20 has a terminal control module 21 used for overall control of the player terminal 20, a terminal storage module 22 used for storing various types of data and programs, a terminal input module 23 used by the player for operation input, a terminal display module 24 used for displaying game screens and operation screens, and a terminal communication module 25 used for communicating information to and from the server device 10.

### <<Operation of Game System 1>>

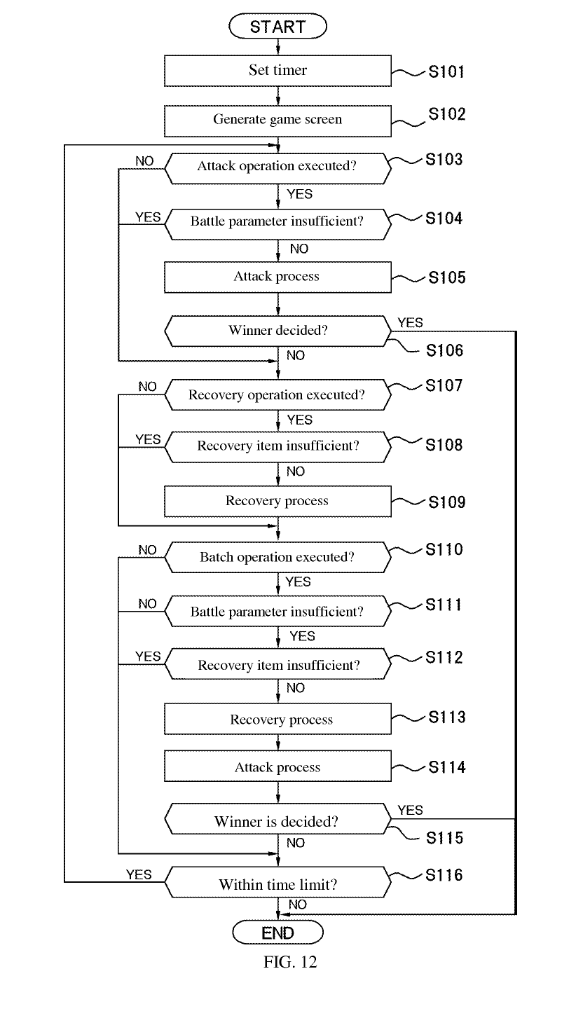

FIG. 12 is a flow chart used to illustrate an example of operation of the game system 1 in the present embodiment. Operations relating to a battle game conducted using player characters and opponent characters determined by matching will be described in specific detail below.

First, upon receiving a battle initiation request from a player terminal 20, the server device 10 sets a timer with a battle time (S101). In the present embodiment, the battle time is set to 60 seconds, and the countdown begins.

Subsequently, the server device 10 directs the screen generation module 114 to generate screen data used to display a game screen (web page) used for gaming operations on the player terminal 20 (S102). The server device 10 then transmits the screen data corresponding to the game screen generated by the screen generation module 114 to the requesting player's terminal 20 over a network. After that, upon receiving the screen data transmitted from the server device 10, the player terminal 20 analyzes the screen data, as a result of which a game screen used for gaming operations is displayed on the terminal display module 24.

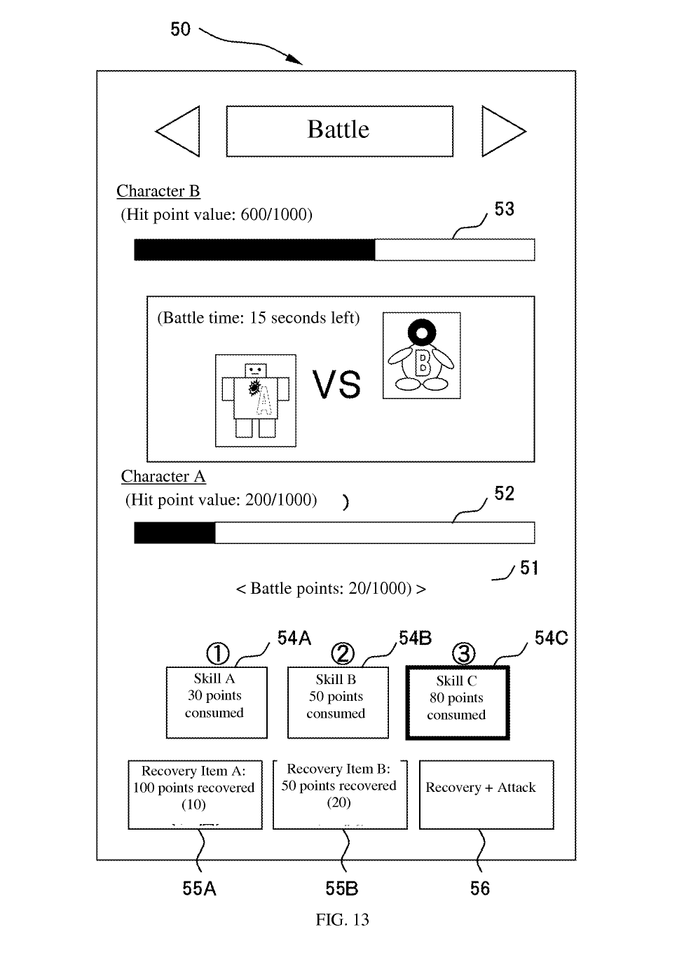

FIG. 13 is a diagram illustrating an example of a game screen 50 used for gaming operations. This game screen 50 includes at least a battle parameter display area 51, a hit point parameter display area 52 configured for the player character and a hit point parameter display area 53 configured for the opponent's character, attack buttons 54A, 54B, and 54C, recovery buttons 55A and 55B, and a batch operation button 56. In the present embodiment, the player can repeatedly select these control buttons while remaining within the battle time.

The battle parameter display area 51 indicates the current value of the battle parameter relative to its maximum value according to the player information illustrated in FIG. 6. As indicated herein, the current value of the battle parameter is 20 points, while the maximum value of the battle parameter is 100 points. In the hit point parameter display areas 52 and 53, bar graphs are used to display the current value of the hit point parameter relative to its maximum value based on the proprietary character information shown in FIG. 7. In the present embodiment, the player whose hit point parameter is reduced to zero first loses the battle.

The attack buttons 54A, 54B, and 54C are control buttons used for attacking the opponent, for which there are respective limited selectable time slots. In the present embodiment, within the 60-second battle time, it is configured such that only the attack button 54A is selectable during the initial 20 seconds, only the attack button 54B is selectable during the next 20 seconds, and only the attack button 54C is selectable during the last 20 seconds. The type of skill allocated to each attack button is decided in accordance with the order based on the skill configuration information illustrated in FIG. 10. For example, when there are 15 seconds of battle time left, only the attack button 54C can be selected as a control button from among the three buttons. For this reason, during an attack in this time slot, the player character can be allowed to actuate only Skill C, which corresponds to the attack button 54C.

The recovery buttons 55A and 55B are control buttons that can be used to recover consumed battle parameters with the help of recovery items. Since the battle parameter recovery value (the maximum value up to which the battle parameter can be recovered using recovery items) varies depending on the type of the recovery items, the player can select an appropriate recovery item, depending on the game situation. The type of the recovery item allocated to each recovery button is decided based on the proprietary item information illustrated in FIG. 8.

The batch operation button 56 is a control button for using a recovery item and attacking an opponent in a single operation. Operational time can be reduced because the player can provide operational input comprising recovery and attack without expending a lot of time and effort. For this reason, the battle game can be conducted to the player's advantage even within a short time limit of 60 seconds.

In this manner, when battle-related operational information is selected and inputted by the player while the game screen 50 illustrated in FIG. 13 is displayed on the player terminal 20, this operational information is transmitted from the player terminal 20 to the server device 10.

Referring back to FIG. 12, the server device 10 then uses the operational information received from the player terminal 20 to carry out a process to determine whether or not an attack operation has been performed (S103). Namely, the determination processing module 112A determines whether any of the attack buttons 54A, 54B, or 54C has been selected by the player. The procedure then advances to Step 107 if said determination is negative (S103: NO), and to Step 104 if said determination is positive (S103: YES).

If it is determined in Step 104 that an attack operation has been performed by the player (S103: YES), a determination is made as to whether or not the player's battle parameter is insufficient. Specifically, in addition to acquiring the value of skill-induced battle parameter consumption of the selected attack button by referring to the skill information illustrated in FIG. 5 and the skill configuration information illustrated in FIG. 10, the determination processing module 112A acquires the current value of the battle parameter by referring to the player information illustrated in FIG. 6. The determination processing module 112A then uses the result of comparing the value of skill-induced battle parameter consumption and the current value of the battle parameter to determine whether or not the battle parameter is insufficient. After that, the procedure advances to Step 107 if said determination is positive (S104: YES), and to Step 105 if said determination is negative (S104: NO).

An attack process is performed if it is determined in Step 105 that the battle parameter is not insufficient (S104: NO). Specifically, the attack processing module 112C subtracts the value of skill-induced battle parameter consumption of the selected attack button from the current value of the battle parameter. Next, the attack processing module 112C uses the skill information illustrated in FIG. 5 and the proprietary character information illustrated in FIG. 7 to calculate an adjusted attack strength resulting from skill actuation. The attack processing module 112C then uses the calculated attack strength to inflict damage by reducing the opponent character's hit point parameter. After that, an attack on the player character is carried out by the opponent character.

Subsequently, as a result of carrying out the attack process in this manner, the determination processing module 112A uses the player character's hit point parameter and the opponent character's hit point parameter to determine whether or not a winner has been decided in this battle (S106). Namely, if the opponent character's hit point parameter is reduced to zero first as a result of the player character's attack, it is decided that the player character has won. The procedure is then terminated if said determination is positive (S106: YES) and advances to Step 107 if said determination is negative (S106: NO).

Subsequently, the server device 10 uses the operational information received from the player terminal 20 to carry out a process to determine whether or not a recovery operation has been performed (S107). Namely, the determination processing module 112A determines whether either of the recovery buttons 55A or 55B has been selected by the player. The procedure then advances to Step 110 if said determination is negative (S107: NO), and to Step 108 if said determination is positive (S107: YES).

If it is determined in Step 108 that a recovery operation has been performed by the player (S107: YES), a determination is made as to whether or not the recovery item owned by the player is insufficient. Specifically, the determination processing module 112A refers to the proprietary item information illustrated in FIG. 8 to determine whether or not the player is in possession of at least one or more recovery items corresponding to the selected recovery button. The procedure then advances to Step 110 if it is determined that the recovery item is insufficient (S108: YES), and to Step 109 if it is determined that the recovery item is not insufficient (S108: NO).

A recovery process is performed if it is determined in Step 109 that the recovery item is not insufficient (S108: NO). Specifically, the recovery processing module 112B recovers the consumed battle parameter with the help of the recovery item owned by the player by adding the value of battle parameter recovery due to the selected recovery item to the current value of the battle parameter.

If, at such time, the current value of the battle parameter is zero, the value of battle parameter recovery due to the selected recovery item will be the maximum value up to which the battle parameter can be recovered using the recovery item. For example, if the upper limit of the battle parameter is “100 points” and the current value is “0 points”, then it is possible to recover “100 points” (i.e. the maximum value that can be recovered using the recovery item). It should be noted that the value of battle parameter recovery due to the selected recovery item may be a value smaller than the maximum value up to which the battle parameter can be recovered using the recovery item. For example, if the upper limit value of the battle parameter is “80 points” and the current value is “0 points”, then “80 points” may be recovered (i.e. a recovery value smaller than “100 points”, which is the maximum value that can be recovered using the recovery item).

However, if the current value of the battle parameter is not zero, then the battle parameter is recovered before being completely used up, and it is only possible to recover a value that is smaller than this maximum value. For example, if the upper limit of the battle parameter is “100 points” and the current value is “20 points”, then only “80 points” can be recovered, which is smaller than “100 points” (i.e. the maximum value that can be recovered using the recovery item). For this reason, some of the recovery value that the recovery item provides (namely, “20 points”) ends up being wasted.

It should be noted that in the present embodiment, the battle parameter can be recovered progressively over time, without relying on the use of recovery items.

Subsequently, the server device 10 uses the operational information received from the player terminal 20 to carry out a process to determine whether or not a batch operation has been performed (S110). Namely, the determination processing module 112A determines whether or not the batch operation button 56 has been selected by the player. The procedure then advances to Step 116 if said determination is negative (S110: NO), and to Step 111 if said determination is positive (S110: YES).

If it is determined in Step 111 that a batch operation has been performed by the player (S110: YES), a determination is made as to whether or not the player's battle parameter is insufficient. Specifically, along with acquiring the value of skill-induced battle parameter consumption in the time slot where the batch operation was performed by referring to the skill information illustrated in FIG. 5 and the skill configuration information illustrated in FIG. 10, the determination processing module 112A acquires the current value of the battle parameter by referring to the player information illustrated in FIG. 6. The determination processing module 112A then uses the result of comparing the value of skill-induced battle parameter consumption and the current value of the battle parameter to determine whether or not the battle parameter is insufficient. After that, the procedure advances to Step 116 if said determination is negative (S111: NO), and to Step 112 if said determination is positive (S111: YES).

If it is determined in Step 112 that the battle parameter is insufficient (S111: YES), a determination is made as to whether or not the recovery item owned by the player is insufficient. Specifically, the determination processing module 112A refers to the proprietary item information illustrated in FIG. 8 to determine whether or not the player is in possession of at least one or more recovery items configured to have the highest recovery value among the recovery items. The procedure then advances to Step 116 if it is determined that the recovery item is insufficient (S112: YES), and to Step 113 if it is determined that the recovery item is not insufficient (S112: NO).

A recovery process is performed if it is determined in Step 113 that the recovery item is not insufficient (S112: NO). Specifically, the recovery processing module 112B recovers the consumed battle parameter with the help of the recovery item configured to have the highest recovery value among the recovery items owned by the player by adding the value of battle parameter recovery due to this recovery item to the current value of the battle parameter. In the present embodiment, the value of battle parameter recovery due to the recovery item is the maximum value up to which the battle parameter can be recovered using the recovery item. For example, if the upper limit of the battle parameter is “100 points” and the current value is “20 points”, then recovery will be performed up to “120 points” by adding “100 points” (i.e. the maximum value that can be recovered using the recovery item). Also, for example, if the upper limit of the battle parameter is “80 points” and the current value is “20 points”, then recovery will also be performed up to “120 points” by adding “100 points” (i.e. the maximum value that can be recovered using the recovery item).

In other words, even when the current value of the battle parameter is not zero, the value added is the maximum value up to which the battle parameter can be recovered when said current value is zero. Accordingly, even if the battle parameter is recovered before being completely used up, this maximum value is added to the remaining unused current value, thereby making it possible to perform recovery by temporarily exceeding the upper limit of the battle parameter. As a result, the battle parameter can be recovered without wasting the remaining unused current value. Furthermore, even if the recovery value provided by the recovery item is higher than the maximum value of the battle parameter, the battle parameter can be recovered without wasting the portion of the recovery value that exceeds the maximum value of the battle parameter.

It should be noted that, computationally, the current value of the battle parameter ends up exceeding the upper limit as a result of said recovery. However, as a result of carrying out the hereinafter described attack process in succession, the value of skill-induced battle parameter consumption is subtracted from the current value. For this reason, on screen, the current value of the battle parameter never exceeds the upper limit. Accordingly, there is no need to reset the upper limit.

Subsequently, if the recovery process is carried out in this manner, an attack process is carried out successively thereafter (S114). Specifically, the attack processing module 112C subtracts the value of skill-induced battle parameter consumption in the time slot where the batch operation was performed from the current value of the battle parameter temporarily exceeding the upper limit. In this manner, the current value that remains unused prior to recovery is consumed at this point. Next, the attack processing module 112C uses the skill information illustrated in FIG. 5 and the proprietary character information illustrated in FIG. 7 to calculate an adjusted attack strength resulting from skill actuation. The attack processing module 112C then uses the calculated attack strength to inflict damage by reducing the opponent character's hit point parameter. After that, an attack on the player character is carried out by the opponent character.

As a result of executing the attack process in this manner, the determination processing module 112A subsequently uses the player character's hit point parameter and the opponent character's hit point parameter to determine whether or not a winner has been decided in this battle (S115). Namely, if the opponent character's hit point parameter is reduced to zero first as a result of the player character's attack, it is decided that the player character has won. The procedure is then terminated if said determination is positive (S115: YES) and advances to Step 116 if said determination is negative (S115: NO).

In Step 116, the determination processing module 112A uses the elapsed time measured by the timer to determine whether or not the battle time is still within the time limit. If said determination is positive (S116: YES), the procedure goes back to Step 103, and a selection operation is subsequently received from the player. On the other hand, this procedure is terminated if said determination is negative (S116: NO).

For example, if in the game system 1 according to the present embodiment, as described above, a player who has a recovery item with a recovery value of “100 points” were to perform a batch operation in a game state in which the remaining current value of the battle parameter is only “20 points”, and in a time slot that permits actuation of a skill with a battle parameter consumption value of “50 points”, then the value added as a result of the automatic use of the recovery item would be “100 points” (i.e. the maximum value that can be recovered when said current value is 0 points). For this reason, the current value of the battle parameter could be recovered up to “120 points”, beyond the upper limit. An attack on the opponent would carried out successively after the recovery, and “50 points (i.e. the value of skill-induced battle parameter consumption) would be subtracted from the current value of the battle parameter that has been recovered up to “120 points”. As a result, the current value of the battle parameter would be updated to “70 points”. By contrast, if the player were to perform a recovery operation, then, despite using a recovery item with a recovery value of “100 points”, it would be possible to recover only “80 points”, which is the upper limit of the battle parameter, in a game state in which the current value of the battle parameter has only “20 points” left. As a result of subtracting “50 points” (i.e. the value of skill-induced battle parameter consumption), when the attack operation is performed after the recovery, the current value of the battle parameter would be updated to “50 points”. Consequently, “20 points” (i.e. the current value that remains unused prior to recovery) would be wasted. In this manner, according to the game system 1 of the present embodiment, the batch operation performed by the player makes it possible to use a recovery item and carry out an attack on an opponent in a single operation while allowing the battle parameter to be recovered without waste.

### Other Embodiments

The foregoing embodiment was intended to facilitate the understanding of the present invention and is not to be construed as limiting of the present invention. The present invention can be modified and improved without departing from its spirit and the present invention includes equivalents thereto. In particular, the embodiments described below are also included in the present invention.

### <Recovery of Battle Parameter>

Although in the present embodiment described above the explanations addressed a case in which the battle parameter is recovered such that, among the recovery items owned by the player, the recovery item that is used when the batch operation is performed by the player is configured to have the highest recovery value among the recovery items, the present invention is not limited thereto.

For example, when the player's battle parameter is recovered, a recovery item capable of making the current value of the recovered battle parameter greater than the value of skill-induced battle parameter consumption during an attack may be selected by the recovery processing module 112B from among the multiple types of recovery items. Specifically, if a player who owns recovery item A with a recovery value of “100 points” and recovery item B with a recovery value of “25 points” were to perform a batch operation in a game state in which the current value of the battle parameter has only “10 points” remaining in a time slot where a skill with a battle parameter consumption value of “50 points” can be actuated, then recovery item A would be automatically used. Since this recovers the current value of the battle parameter up to “110 points”, it becomes possible to actuate the attack skill by successively consuming “50 points”. If recovery item B were to be automatically used, then the current value of the battle parameter could only be recovered up to 35 points. For this reason, it would be impossible to attack successively after the recovery.

In addition, for example, when the player's battle parameter is recovered, the recovery processing module 112B may select a recovery item with the lowest maximum value that can be recovered when the current value of the battle parameter is zero from among the multiple types of recovery items capable of making the current value of the recovered battle parameter greater than the value of skill-induced battle parameter consumption during an attack. Specifically, if a player who owns recovery item A with a recovery value of “100 points” and recovery item C with a recovery value of “50 points” were to perform a batch operation in a game state in which the current value of the battle parameter has only “90 points” remaining in a time slot where a skill with a battle parameter consumption value of “95 points” can be actuated, then recovery item C would be automatically used. Since this recovers the current value of the battle parameter up to “145 points”, it becomes possible to actuate the attack skill by successively consuming “90 points”. In other words, the skill could be actuated during the following attack successively after using the minimum recovery value. If recovery item A were to be automatically used, then the current value of the battle parameter would be recovered up to “190 points” and, in the same manner as in the case of recovery item C, it would also be possible to actuate the attack skill by successively consuming “90 points”. However, in the case of recovery item A the recovery would be excessive in comparison with recovery item C.

In addition, in the present embodiment described above, although the explanations addressed a case in which the battle parameter is recovered using a recovery item when the batch operation is performed by the player, the present invention is not limited thereto. For example, the battle parameter may be recovered without using recovery items.

### <Server Device>

In the present embodiments as described above, the explanations are given with reference to a game system 1 equipped with a single server device 10 as an example of a service device. The invention, however, is not limited thereto and a game system 1 equipped with multiple server devices 10, as an example of server devices, may also be used. In other words, multiple server devices 10 may be connected over a network 2 and these server devices 10 may perform various types of processing in a distributed manner. It should be noted that the server device 10 is an example of a computer.

### <Information Processing Device>

In the game system 1 used in the present embodiment as described above, the explanations are given with reference to a case in which various types of information processing are carried out by directing the server device 10 and the player terminals 20 to cooperate based on a game program. The invention, however, is not limited thereto and the above-mentioned various types of information processing may be carried out based on the game program using the server device 10 alone or the player terminals 20 alone as information processing devices.

In addition, a configuration may be used in which the player terminals 20 support part of the information processing device functionality. In such a case, the server device 10 and player terminals 20 constitute an information processing device.

It should be noted that the information processing device is an example of a computer equipped with a processor and a memory.

### DESCRIPTIONS OF THE REFERENCE NUMERALS

1 Game system
2 Network
3 Server device
4 Control module
5 Storage module
6 Input module
7 Display module
8 Communication module
9 Player terminal
10 Terminal control module
11 Terminal storage module
12 Terminal input module
13 Terminal display module
14 Terminal communication module
15 Game screen
16 Battle parameter display area
17 Hit point parameter display area
18 Hit point parameter display area
19 54A Attack button
20 54B Attack button
21 54C Attack button
22 55A Recovery button
23 55B Recovery button
24 Batch operation button
25 111 Acceptance processing module
26 112 Battle processing module
27 112A Determination processing module
28 112B Recovery processing module
29 112C Attack processing module
30 113 Recording processing module
31 114 Screen generation module

1. A non-transitory computer readable medium having machine-executable instructions with which a computer having a storage and a hardware processor, for providing a service, said machine-executable instructions comprising:
a recording process which records a battle parameter consumed during a battle with an opponent and a recovery item for recovering the battle parameter in a storage module in association with a player, and
as a result of the player performing a batch operation for recovering the battle parameter and carrying out an attack on the opponent in a single operation,
a determination process which determines whether or not the player's battle parameter is insufficient based on the result of comparing the value of attack-induced consumption of the battle parameter and the current value of the battle parameter; and
if it is determined that the player's battle parameter is insufficient,
a recovery process which recovers the player's battle parameter with the help of the player's recovery item by adding the value of battle parameter recovery due to said recovery item to the current value of the battle parameter; and
a battle process which successively carries out an attack process in which an attack is carried out on the opponent by subtracting the value of attack-induced consumption of the battle parameter from the current value of the recovered battle parameter.

2. The non-transitory computer readable medium according to claim 1, wherein the battle process successively carries out the determination process, the recovery process, and the attack process only if the batch operation has been performed by the player within a preset time limit.

3. The non-transitory computer readable medium according to claim 2, wherein:
the time limit is divided into preset predetermined periods,
the battle process authorizes the player's attack operation, which is used only to carry out an attack on the opponent, to be repeatedly performed within the time limit, and
the attack process incrementally subtracts the value of attack-induced consumption of the battle parameter, in fixed amounts corresponding to each of the predetermined periods, from the current value of the battle parameter whenever the player's attack operation is performed in each of the predetermined periods.

4. The non-transitory computer readable medium according to claim 1, wherein:
the recording process records, in the storage module in association with players, multiple types of the recovery items with respectively different maximum values up to which the battle parameter can be recovered when the current value of the battle parameter is zero, and
when the player's battle parameter is recovered, the recovery process selects a recovery item capable of making the current value of the recovered battle parameter greater than the value of attack-induced consumption of the battle parameter from among the multiple types of recovery items.

5. The non-transitory computer readable medium according to claim 1, wherein:
the recording process records, in the storage module in association with players, multiple types of the recovery items with respectively different maximum values up to which the battle parameter can be recovered when the current value of the battle parameter is zero, and
when the player's battle parameter is recovered, the recovery process selects a recovery item with the lowest maximum value up to which the battle parameter can be recovered when the current value of the battle parameter is zero, from among the multiple types of the recovery items capable of making the current value of the recovered battle parameter greater than the value of attack-induced consumption of the battle parameter.

6. An information processing device provided with:
a storage module which stores a battle parameter consumed during a battle with an opponent and a recovery item for recovering the battle parameter in association with a player, and
as a result of the player performing a batch operation for recovering the battle parameter and carrying out an attack on the opponent in a single operation,
a determination processing module which determines whether or not the player's battle parameter is insufficient based on the result of comparing the value of attack-induced consumption of the battle parameter and the current value of the battle parameter, and
if it is determined that the player's battle parameter is insufficient,
a recovery processing module which recovers the player's battle parameter with the help of the player's recovery item by adding the value of battle parameter recovery due to said recovery item to the current value of the battle parameter, and
a battle processing module which possesses functionality to successively carry out an attack process in which an attack is carried out on the opponent by subtracting the value of attack-induced consumption of the battle parameter from the current value of the recovered battle parameter.
